(19) United States
(12) Patent Application Publication
(10) Pub. No.: US 2025/0180514 A1
(43) Pub. Date: Jun. 5, 2025

(54) Non-Invasive Multiparameter Sensor

(71) Applicant: Wisconsin Alumni Research Foundation, Madison, WI (US)

(72) Inventors: Joseph Andrews, Madison, WI (US); Brian Cardwell, Northville, MI (US); Maimaitiaizezi Tuxunniyazi, Madison, WI (US)

(21) Appl. No.: 18/524,946

(22) Filed: Nov. 30, 2023

(51) Int. Cl. G01N 27/60

(52) U.S. Cl. CPC G01N 27/60

(57) ABSTRACT

A sensor and method of interrogating a fluid for multiple parameters is provided. An AC signal is applied to a first electrode in proximity to a fluid so as to induce an electric field to interact with the fluid. A reflected AC signal is measured at a second electrode in response to the interaction of the electric field with the fluid and various parameters of the fluid may be determined in response to the reflected AC signal.

### FIELD OF THE INVENTION

The present invention relates generally to sensor technology, and in particular, to a sensor and method for interrogating a fluid for multiple parameters simultaneously.

### BACKGROUND AND SUMMARY OF THE INVENTION

It has been estimated that in 2022 alone, the global total emission of CO₂ from the burning of fossil fuels and the production of cement products exceeded 36 billion metric tons (36 metric gigatons) with ground transportation accounting for nearly 18% of this total. In an attempt to curb carbon emissions, governments and industries have turned their attention to the reduction or elimination of carbon pollution by 2050 by mandating the production and sale of zero carbon emission light passenger vehicles by 2035. Currently, the most popular form of vehicle meeting this definition is a battery electric vehicle (BEV).

These rechargeable BEV applications typically rely on the electrical energy stored and delivered using reversible chemical reactions within individual battery cells. The temperature of these batteries and the thermal gradient during operation within the individual cells must be well controlled to optimize charging/discharging performance, extend the useful life of the battery, and avoid excessively high temperatures that could result in a catastrophic thermal run-away event.

Although there are many different battery thermal management techniques, the growing majority of these involve the utilization of ethylene glycol/water coolant mixtures to transfer heat. Accurate measurement of a variety of different fluid intrinsic physical properties has become increasingly important when attempting to optimize the performance of modern thermal management systems that utilize aqueous ethylene glycol mixtures as heat transfer media. These fluid physical properties are traditionally measured independently using multiple discrete sensors which rely on a variety of sensing techniques. As the number of measured parameters increases, the cost, system complexity, packaging space, and control system inputs and outputs increase for discrete sensors. Consequently, it can be appreciated that it would be desirable to provide a single sensor technology that has the ability to interrogate a fluid used as a heat transfer media for multiple parameters simultaneously.

Therefore, it is a primary object and feature of the present invention to provide a sensor and method for interrogating a fluid for multiple parameters simultaneously.

It is further object and feature of the present invention to provide a sensor and method for interrogating a fluid for multiple parameters non-invasively from a location in proximity to the fluid.

It is a still further object and feature of the present invention a sensor and method for interrogating a fluid for multiple parameters that is simple and inexpensive.

In accordance with the present, a sensor is provided for interrogating a fluid for multiple parameters. The sensor includes first and second electrodes positionable in proximity to the fluid. An AC source is operatively connected to the first electrode. The AC source is configured to selectively apply an AC signal to first and second electrodes thereby inducing an electric field to interact with the fluid. An analyzer is operatively connected to the second electrode and is configured to measure a reflected AC signal in response to the interaction of the electric field with the fluid.

It is contemplated for each of the first and second electrodes to include a base portion having a plurality of legs projecting therefrom. The plurality of legs of the first electrode are interdigitated with the plurality of legs of the second electrode. The sensor also includes a flexible first layer having a first face positionable adjacent to fluid and a second face. The first and second electrodes are bonded to the second face. A flexible second layer may be bonded to the first layer and the first and second electrodes. A SubMiniature version A (SMA) connecter may be operatively connected to the first and second electrodes.

The analyzer is configured to determine a temperature of the fluid in response to the reflected AC signal. The temperature of the fluid is determined by comparing to a signal reflectance of the reflected AC signal to a map. In addition, the analyzer is configured to determine a composition of the fluid in response to the reflected AC signal. The composition of the fluid is determined by comparing to a signal reflectance of the reflected AC signal to a map. The AC source is configured to selectively apply the AC signal to first and second electrodes at a plurality of frequencies.

In accordance with a further aspect of the present invention, a method of interrogating a fluid for multiple parameters is provided. The method includes the step of applying an AC signal to a first electrode in proximity to a fluid so as to induce an electric field to interact with the fluid. A reflected AC signal is measured at a second electrode in response to the interaction of the electric field with the fluid. A first parameter of the fluid is determined in response to the reflected AC signal. In addition, a second parameter of the fluid may be determined in response to the reflected AC signal.

The first and second electrodes include a base portion having a plurality of legs projecting therefrom. The plurality of legs of the first electrode are interdigitated with the plurality of legs of the second electrode. The first and second electrodes are bonded to a flexible layer and the flexible layer is positioned adjacent to a conduit carrying the fluid. The first parameter may be temperature or a composition of the fluid. The first parameter is determined by comparing a signal reflectance of the reflected AC signal to a map. The AC signal may be selectively applied to first and second electrodes at a plurality of frequencies.

In accordance with a still further aspect of the present invention, a method is provided for interrogating a fluid having a plurality of parameters. Each parameter has a plurality of values. The method includes the step of applying AC signals in proximity to a fluid at a plurality of frequencies while maintaining a first parameter of the fluid at a first value of the plurality of values. Each AC signal generates a corresponding electric field which interacts with the fluid. The AC signals are reapplied at the plurality of frequencies while maintaining the first parameter of the fluid at a second value of the plurality of values. Reflected AC signals generated in response to the interaction of the electric field with the fluid in response to the application of the AC signals are measured and a map is generated in response to the reflected AC signals. An interrogating AC signal is applied in proximity to the fluid so as to induce an interrogating electric field to interact with the fluid. A reflected interrogating AC signal in response to the interaction of the interrogating electric field with the fluid is measured and a signal reflectance of the reflected interrogating AC signal is compared to the map to determine a value of the first parameter of the fluid.

A second set of AC signals may be applied in proximity to the fluid at a plurality of frequencies while maintaining a second parameter of the fluid at a first value of a plurality of values. Each AC signal of the second set of AC signals generates a corresponding electric field which interacts with the fluid. The second set of AC signals is reapplied at the plurality of frequencies while maintaining the second parameter of the fluid at a second value of the plurality of values of the second parameter. Reflected second set of AC signals generated in response to the interaction of the electric field with the fluid is measured in response to the application of the second set of AC signals and a second map is generated in response to the reflected second set of AC signals.

The signal reflectance of the reflected interrogating AC signal may be compared to the second map to determine a value of the second parameter of the fluid. The interrogating AC signal may applied in proximity to the fluid at a plurality of frequencies. It is contemplated to apply the interrogating AC signals to a first electrode and measure the reflected the interrogating AC signals at a second electrode. The first and second electrodes include a base portion having a plurality of legs projecting therefrom. The plurality of legs of the first electrode are interdigitated with the plurality of legs of the second electrode. The first and second electrodes are bonded to a flexible layer and the flexible layer is positioned adjacent to a conduit carrying the fluid.

The flexible layer may be a first flexible layer and the method further include the additional step of bonding a second flexible layer to the first flexible layer and to the first and second electrodes so as to capture the first and second electrodes therebetween.

### BRIEF DESCRIPTION OF THE DRAWINGS

Preferred exemplary embodiments of the invention are illustrated in the accompanying drawings in which like reference numerals represent like parts throughout, and in which:

FIG. 1 is a top plan view of a sensor in accordance with one embodiment of the present invention;

FIG. 2 is a cross-sectional view of the sensor of the present invention taken along line 2-2 of FIG. 1;

FIG. 3 is a cross-sectional view of the sensor of the present invention taken along line 3-3 of FIG. 1;

FIG. 4 is a cross-sectional view of the sensor of the present invention taken along line 4-4 of FIG. 2;

FIG. 5 is a schematic view showing the sensor of the present in operation;

FIG. 6 is a graph showing signal reflectance in decibels of three fluid mixtures at three distinct temperatures versus frequency;

FIG. 7 is an enlarged portion of the graph of FIG. 6.

### BRIEF DESCRIPTION OF THE DRAWINGS

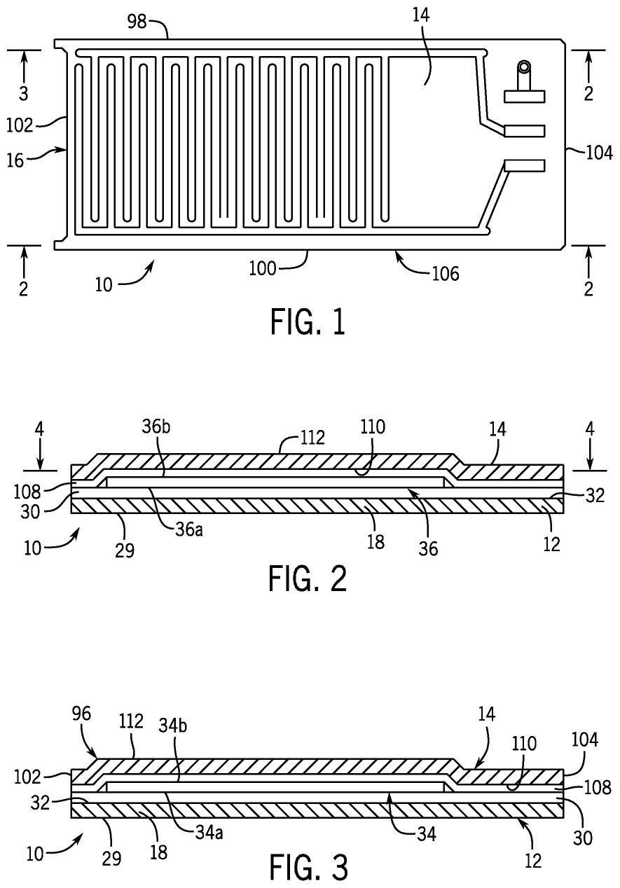

Referring to FIGS. 1-3, a sensor in accordance with the present inventions is generally designated by the reference numeral 10. In the depicted embodiment, sensor 10 has a generally rectangular configuration having includes first and second faces 12 and 14, respectively, interconnected by outer periphery 16. However, it can be appreciated that sensor 10 may have other configurations without deviating from the scope of the present invention.

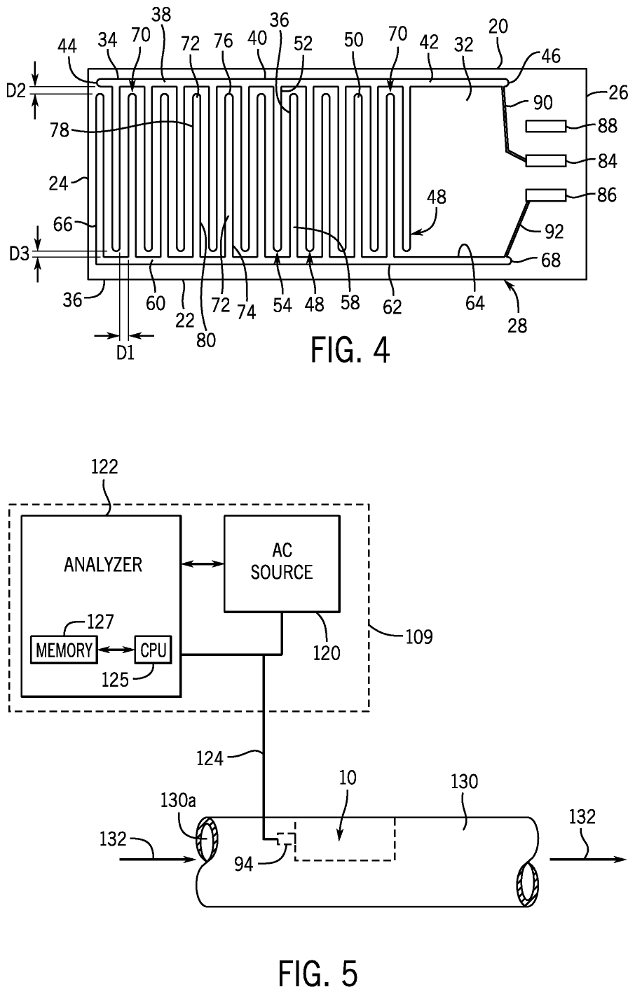

Referring to FIGS. 2-4, sensor 10 includes first layer 18 fabricated from a flexible material, e.g. polyimide, having a thickness, e.g. 25 micrometers. First layer 18 has a generally rectangular configuration and is defined by first and second sides 20 and 22, respectively, and first and second ends 24 and 26, respectively, which define outer periphery 28 thereof. First face 29 of first layer 18 defines first face 12 of sensor 10. An adhesive 30 of a desired thickness, e.g. 13 micrometers, is deposited on second side 32 of first layer 18. First and second interdigitated electrodes 34 and 36, respectively, having corresponding first sides 34a and 36a, respectively, bonded to the second side 32 of first layer 26 by adhesive 30. It is contemplated for interdigitated, first and second electrodes 34 and 36, respectively, to be fabricated from copper. However, it can be understood that first and second electrodes 34 and 36, respectively, may be fabricated from other materials without deviating from the scope of the present invention.

In the depicted embodiment, first and second electrodes 34 and 36, respectively, have a generally comb-like shape. More specifically, first electrode 34 includes an elongated base portion 38 having a first side 40 spaced from and generally parallel to first side 20 of first layer 18, a second side 42 spaced from and generally parallel to second side 22 of first layer 18, a first end 44 spaced from first end 24 of first layer 18 and a second end 46 spaced from second end 26 of first layer 18. A plurality of spaced legs 48 project from second side 42 of first electrode 34 along corresponding axes toward second side 22 of first layer 18. Each leg 50 of the plurality of spaced legs 48 is defined by a first end 52 integral with second side 42 of base portion 38 of first electrode 34 and an opposite, terminal end 54. First end 52 and terminal end 54 of each leg 50 are interconnected by first and second parallel sides 56 and 58, respectively, which are perpendicular to second side 42 of base portion 38 of first electrode 34 and parallel to first and second ends 24 and 26, respectively, of first layer 18.

Similarly, second electrode 36 includes an elongated base portion 60 having a first side 62 spaced from and generally parallel to second side 22 of first layer 18, a second side 64 spaced from and generally parallel to second side 42 of base portion 38 of first electrode 34, a first end 66 spaced from first end 24 of first layer 18 and a second end 68 spaced from second end 26 of first layer 18. A plurality of spaced legs 70 project from second side 64 of second electrode 36 along corresponding axes toward second side 42 of base portion 38 of first electrode 34. The plurality of spaced legs 70 of second electrode 36 are interdigitated with the plurality of spaced legs 48 of first electrode such that each leg 72 of the plurality of spaced legs 70 of first electrode 34 is spaced from an adjacent leg 50 of the plurality of spaced legs 48 of second electrode by a distance D1, e.g. 1 millimeter (mm).

Each leg 72 of the plurality of spaced legs 70 of first electrode 34 is defined by a first end 74 integral with second side 64 of base portion 60 of second electrode 36 and an opposite, terminal end 76. Terminal end 76 of each leg 72 of the plurality of spaced legs 70 of second electrode 36 is spaced from second side 42 of base portion 38 of first electrode 34 by a distance D2, e.g. 1 mm. Likewise, terminal end 76 of each leg 50 of the plurality of spaced legs 48 of first electrode 34 is spaced from second side 64 of base portion 60 of second electrode 36 by a distance D3, e.g. 1 mm. In addition, first end 74 and terminal end 76 of each leg 72 of the plurality of spaced legs 70 of second electrode 36 are interconnected by first and second parallel sides 78 and 80, respectively, which are perpendicular to second side 64 of base portion 60 of second electrode 36 and parallel to first and second ends 24 and 26, respectively, of first layer 18. It is intended for the distances D1, D2 and D3 to be of such dimension so as to allow the expected height of an electric field generated between first and second electrodes 34 and 36, respectively, as hereinafter described, to be of sufficient height to extend well past the first layer 18 and interact with a fluid in proximity thereto.

Sensor 10 further includes signal trace 84 and first and second ground traces 86 and 88, respectively, bonded to the second side 32 of first layer 26 by adhesive 30 at a location adjacent second end 26 of first layer 18. It is contemplated for signal trace 84 and first and second ground traces 86 and 88, respectively, to be fabricated from copper. However, it can be understood that signal trace 84 and first and second ground traces 86 and 88, respectively, may be fabricated from other materials without deviating from the scope of the present invention. Signal trace 84 is electrically coupled to second end 46 of base portion 38 of first electrode 34 by trace 90. First ground trace 86 is electrically coupled to second end 68 of base portion 60 of second electrode 36 by trace 92. SubMiniature version A (SMA) connector 94. FIG. 5, includes first and second body connectors electrically coupled to first and second ground traces 86 and 88, respectively, and a center connector electrically coupled to signal trace 84.

Referring back to FIGS. 1-3, sensor 10 further includes second layer 96 fabricated from a flexible material, e.g. polyimide, having a thickness, e.g. 12.5 micrometers. Second layer 96 has a generally rectangular configuration and is defined by first and second sides 98 and 100, respectively, and first and second ends 102 and 104, respectively, which define outer periphery 106 thereof. Second layer 96 further includes first and second faces 110 and 112, respectively. To assemble sensor 10, second layer 96 is positioned on first layer 18 such that outer periphery 106 of second layer 96 is aligned with outer periphery 28 of first layer 18. Adhesive 108 is deposited between first face 110 of second layer 96 and second sides 34b and 36b of first and second electrodes 34 and 36, respectively, to bond second layer 96 to second sides 34b and 36b of first and second electrodes 34 and 36, respectively. In addition, adhesive 108 is deposited between adhesive 30 and second face 112 of second layer 96 to bond second layer 96 to first layer 18. It is contemplated for adhesive 108 to have a desired thickness, e.g. 15 micrometers. In its assembled configuration, outer periphery 106 of second layer 96 and outer periphery 28 of first layer define outer periphery 16 of sensor 10. In addition, second face 112 of second layer 96 defines second face 14 of sensor 10.

Referring to FIG. 5, sensor 10 is intended to be operatively connected to controller 109 including AC source 120 and analyzer 122. More specifically, it is contemplated to interconnect the central conductor of coaxial cable 124 to AC source 120 and to signal trace 84 via SCA connector 94. The external conductor of coaxial cable 124 interconnects analyzer 122 to first and second ground traces 86 and 88, respectively, via SCA connector 94. As hereinafter described, it is intended for AC source 120 to supply an AC signal, for example, an AC voltage signal having a magnitude and a frequency to first electrode 34, thereby generating an electric field. Analyzer 122 communicates with AC source 120 and includes a processor 125 and software stored in computer-readable memory 127 for effectuating the methodology of the present invention. More specifically, processor 125 controls the magnitude and frequency of the AC signal provided to sensor 10 by AC source 120. In addition, it contemplated for analyzer 122 to measure the reflected AC signal at first and second ground traces 86 and 88, respectively.

In operation, first face 12 of sensor 10 is positioned on conduit 130 carrying a fluid, generally designated by the reference numeral 132. Sensor 10 may be retained on conduit 130 in any conventional manner such as by an adhesive, a clamp or the like. An AC signal is applied by AC source 120 to first electrode 34. It is contemplated to apply an AC voltage at a selected magnitude, e.g. 225 mV, and at a selected frequency, e.g. between 1-500 MHz for a predetermined period of time, e.g. 5.33 milliseconds. An electric field is generated in response to application of the AC signal to first electrode 34. As described above, the electric field is of sufficient height so as to extend past the first layer 18 and conduit 130 and into interior 130a of conduit 130 so as to interact with fluid 132 therein. The process is repeated for multiple frequencies in the noted range (e.g., 8192 data points).

As is known, the complex permittivity of a fluid, e.g. fluid 132, is modified by physical parameters, such as temperature or volumetric composition. As such, as hereinafter described, the reflected AC signal measured at first ground trace 86 may be used to determine the change in the permittivity of fluid 132 resulting from changes in the physical parameters thereof. More specifically, analyzer 122 measures the magnitude and frequency of the reflected AC signal at first ground trace 86 at each frequency, or in other words, at each of the above-noted data points. Thereafter, after analyzer 122 calculates the signal reflectance S₁₁. As is known, signal reflectance S₁₁ is defined as is defined as the ratio between the reflected AC signal and the applied AC signal and may be calculated according to the expression:

$${S}_{11} = - 10 {log}_{10} ( \frac{{P}_{ref}}{{P}_{app}} ) \qquad Equation ( 1 )$$

wherein
S₁₁ is the signal reflectance, P_{ref} is the reflected power, and Pₐₚₚ is the applied power.

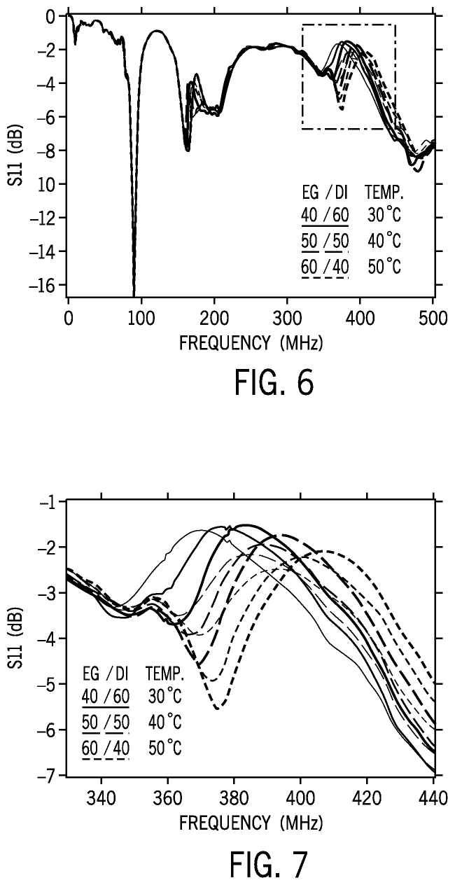

Once the signal reflectance S₁₁ is determined, analyzer 122 may compare the signal reflectance S₁₁ to a previously compiled map of signal reflectance S₁₁ for a particular fluid at a particular temperature when the particular fluid interacts with an AC signal of a predetermined magnitude over a range of frequencies, e.g. between 1-500 MHz. By way of example, referring to FIG. 6, a sample map showing various volumetric mixtures of ethylene glycol (EG) and deionized (DI) water at preselected temperatures is depicted. As noted above, this fluid mixture application relevance for use as vehicular heat transfer media, particularly in BEVs. More specifically, FIG. 6 depicts a spectra of signal reflectance S₁₁ three different volumetric compositions (40, 50, and 60% EG by volume) of a fluid at three different temperatures (30, 40, and 50° C.).

FIG. 7 depicts an enlarged portion of the sample map of FIG. 6 show a spectral region in the frequency regime 300-450 Mhz. It can be appreciated that the differences in the volumetric composition of the fluid and the differences in temperature causes increased spectral separation in the signal reflectance S₁₁. It can be appreciated that two distinctive phenomena are associated with each independent variable, namely the temperature and volumetric composition. First, the temperature increase causes a frequency shift within the data. This corresponds to the decrease in the dielectric constant that occurs within EG/DI mixtures as the temperature is increased. Second, as the magnitude of signal reflectance S₁₁ changes as the volume percent of EG is increased. This is due to a combination of the decrease in dielectric constant and increase in loss tangent that is exhibited within higher concentration solutions of EG.

In view of the foregoing, it can be appreciated that by comparing signal reflectance S₁₁ to a previously compiled map of signal reflectance S₁₁ for a particular fluid, analyzer 122 may simply and easily determine the physical properties, such as temperature and fluid composition, of fluid 132 in a non-invasive manner with sensor 10 in proximity to fluid 132.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

It should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

We claim:

1. A sensor for interrogating a fluid for multiple parameters, comprising:
first and second electrodes positionable in proximity to the fluid;
an AC source operatively connected to the first electrode, the AC source configured to selectively apply an AC signal to first electrode thereby inducing an electric field to interact with the fluid; and
an analyzer operatively connected to the second electrode and configured to measure a reflected AC signal in response to the interaction of the electric field with the fluid.

2. The sensor of claim 1 wherein each of the first and second electrodes include a base portion having a plurality of legs projecting therefrom, the plurality of legs of the first electrode interdigitated with the plurality of legs of the second electrode.

3. The sensor of claim 1 further comprising a flexible first layer, the first layer having a first face positionable adjacent to fluid and a second face, wherein the first and second electrodes are bonded to the second face.

4. The sensor of claim 1 further comprising a flexible second layer, the second layer bonded to the first layer and the first and second electrodes.

5. The sensor of claim 1 further comprising a SubMiniature version A (SMA) connecter operatively connected to the first and second electrodes.

6. The sensor of claim 1 wherein the analyzer is configured to determine a temperature of the fluid in response to the reflected AC signal.

7. The sensor of claim 6 wherein the temperature of the fluid is determined by comparing to a signal reflectance of the reflected AC signal to a map.

8. The sensor of claim 1 wherein the analyzer is configured to determine a composition of the fluid in response to the reflected AC signal.

9. The sensor of claim 8 wherein the composition of the fluid is determined by comparing to a signal reflectance of the reflected AC signal to a map.

10. The sensor of claim 1 wherein the AC source is configured to selectively apply the AC signal to first and second electrodes at a plurality of frequencies.

11. A method of interrogating a fluid for multiple parameters, comprising the steps of:
applying an AC signal to a first electrode in proximity to a fluid so as to induce an electric field to interact with the fluid;
measuring a reflected AC signal at a second electrode in response to the interaction of the electric field with the fluid; and
determining a first parameter of the fluid in response to the reflected AC signal.

12. The method of claim 11 comprising the additional step of determining a second parameter of the fluid in response to the reflected AC signal.

13. The method of claim 11 wherein the first and second electrodes include a base portion having a plurality of legs projecting therefrom, the plurality of legs of the first electrode interdigitated with the plurality of legs of the second electrode.

14. The method of claim 11 comprising the additional steps of:
bonding the first and second electrodes to a flexible layer; and
positioning the flexible layer adjacent to a conduit carrying the fluid.

15. The method of claim 11 wherein the first parameter is temperature.

16. The method of claim 11 wherein the first parameter is a composition of the fluid.

17. The method of claim 11 wherein the first parameter is determined by comparing a signal reflectance of the reflected AC signal to a map.

18. The method of claim 11 comprising the additional step of selectively applying the AC signal to first and second electrodes at a plurality of frequencies.

19. A method of interrogating a fluid having a plurality of parameters, each parameter having a plurality of values, comprising the steps of:
applying AC signals in proximity to a fluid at a plurality of frequencies while maintaining a first parameter of the fluid at a first value of the plurality of values,
wherein each AC signal generates a corresponding electric field which interacts with the fluid;
reapplying the AC signals at the plurality of frequencies while maintaining the first parameter of the fluid at a second value of the plurality of values;
measuring reflected AC signals generated in response to the interaction of the electric field with the fluid in response to the application of the AC signals;
generating a map in response to the reflected AC signals;
applying an interrogating AC signal in proximity to the fluid so as to induce an interrogating electric field to interact with the fluid;
measuring a reflected interrogating AC signal in response to the interaction of the interrogating electric field with the fluid; and
comparing a signal reflectance of the reflected interrogating AC signal to the map to determine a value of the first parameter of the fluid.

20. The method of claim 19 comprising the additional steps of:
applying a second set of AC signals in proximity to the fluid at a plurality of frequencies while maintaining a second parameter of the fluid at a first value of a plurality of values, wherein each AC signal of the second set of AC signals generates a corresponding electric field which interacts with the fluid;
reapplying the second set of AC signals at the plurality of frequencies while maintaining the second parameter of the fluid at a second value of the plurality of values of the second parameter;
measuring reflected second set of AC signals generated in response to the interaction of the electric field with the fluid in response to the application of the second set of AC signals; and
generating a second map in response to the reflected second set of AC signals.

21. The method of claim 20 comprising the additional steps of comparing the signal reflectance of the reflected interrogating AC signal to the second map to determine a value of the second parameter of the fluid.

22. The method of claim 19 wherein the interrogating AC voltage signal is applied in proximity to the fluid at a plurality of frequencies.

23. The method of claim 19 wherein the interrogating AC signals are applied to a first electrode and the reflected interrogating AC signal is measured at a second electrode, each of the first and second electrodes include a base portion having a plurality of legs projecting therefrom, the plurality of legs of the first electrode interdigitated with the plurality of legs of the second electrode.

24. The method of claim 23 comprising the additional steps of:
bonding the first and second electrodes to a flexible layer; and
positioning the flexible layer adjacent to a conduit carrying the fluid.

25. The method of claim 24 wherein the flexible layer is a first flexible layer and wherein the method further comprises the additional step of bonding a second flexible layer to the first flexible layer and the first and second electrodes so as to capture the first and second electrodes therebetween.
